(19) United States
(12) Patent Application Publication
(10) Pub. No.: US 2025/0377479 A1
(43) Pub. Date: Dec. 11, 2025

(54) CALCULATION METHOD FOR ELASTIC MODULUS OF SOIL-ROCK MIXTURE BASED ON MESO-STRUCTURE MODEL

(71) Applicants: JIANGXI UNIVERSITY OF SCIENCE AND TECHNOLOGY, Ganzhou City (CN); HOHAI UNIVERSITY, Nanjing (CN); JSTI GROUP, Nanjing (CN)

(72) Inventors: Maosen CAO, Nanjing (CN); Mei TAO, Nanjing (CN); Tongfa DENG, Ganzhou City (CN); Dragoslav SUMARAC, Ganzhou City (CN); Qingwen REN, Nanjing (CN); Linfei ZHANG, Nanjing (CN); Jiafeng GU, Nanjing (CN); Lixia PAN, Nanjing (CN); Jiayi PENG, Nanjing (CN)

(73) Assignees: JIANGXI UNIVERSITY OF SCIENCE AND TECHNOLOGY, Ganzhou City, JX (CN); HOHAI UNIVERSITY, Nanjing, JS (CN); JSTI GROUP, Nanjing, JS (CN)

(21) Appl. No.: 18/735,228

(22) Filed: Jun. 6, 2024

(51) Int. Cl. G01V 20/00; G06F 30/23; G06F 111/10; G06F 119/14

(52) U.S. Cl. CPC G01V 20/00; G06F 30/23; G06F 2111/10; G06F 2119/14

(57) ABSTRACT

The invention provides a calculation method for the elastic modulus of a soil-rock mixture based on a mesoscopic structure model, relevant to the field of meso-numerical simulation of geotechnical materials. It includes the following steps: obtaining the gradation curve of soil-rock mixture particles through a screening test and constructing a two-dimensional random meso-structure model of the mixture with varying stone contents. Using the finite element method, a biaxial compression numerical test is conducted on the model under different stone contents and confining pressures. The equivalent elastic modulus of the mixture is determined by the corresponding secant elastic modulus at an axial strain of 1%. This macro-equivalent elastic modulus, considering stone content and confining pressure, is then fitted. This method effectively addresses the challenge of presenting accurate physical and mechanical parameters in engineering design and construction, making it directly applicable to practical engineering involving soil-rock mixture materials.

### TECHNICAL FIELD

The invention relates to the field of mesoscopic numerical technology of geotechnical materials, in particular to a calculation method for an elastic modulus of soil-rock mixture based on a mesoscopic structure model.

### BACKGROUND ART

In practical engineering, the physical and mechanical properties of soil-rock mixture materials are not only mainly affected by the material composition and structure of geotechnical materials, but also mainly affected by the occurrence environment, especially the in-situ stress environment. It can be seen that the elastic modulus, as an important physical and mechanical parameter of the soil-rock mixture, is not only affected by the stone content, but also has the confining pressure effect caused by the in-situ stress.

Due to the complex fabric characteristics of the soil-rock mixture, it has a high degree of inhomogeneity, discontinuity, spatial variability, and environmental dependence. Due to the different contents of the internal components, and the differences in particle shape, spatial distribution, and arrangement, the macro and micro mechanical properties are very different. The traditional macroscopic analysis method cannot consider the internal meso-structure characteristics, and it is difficult to describe the meso-mechanics between different components and the influence of meso-structure on macro-mechanical properties. The development of the numerical simulation method based on the meso-structure model provides the possibility to study the meso-structural mechanical characteristics and macro-mechanical behavior of materials, and then put forward the relationship between meso-structural characteristics, external factors, and macro-physical and mechanical parameters. In the previous study of soil-rock mixture, the mechanical parameters of the soil-rock mixture are usually determined by only testing the soil matrix in the soil-rock mixture and multiplying by a certain correction coefficient. This method has great randomness and cannot consider and describe the influence of internal structure on the macroscopic mechanical properties of materials.

### SUMMARY

In order to solve the above problems, the invention proposes a calculation method for the elastic modulus of soil-rock mixture based on a mesoscopic structure model, which effectively solves the problem that it is difficult to present effective physical and mechanical parameters in engineering design and construction, and can be directly used in practical engineering composed of soil-rock mixture materials.

In order to achieve the above purpose, the invention discloses the following technical solution.

A calculation method for an elastic modulus of soil-rock mixture based on a mesoscopic structure model comprises the following steps:
obtaining a grading curve of soil-rock mixture particles by a screening test, and constructing a two-dimensional random meso-structure model of soil-rock mixture with different stone contents according to the grading curve;
using a finite element method to carry out a biaxial compression numerical test of different confining pressures on the two-dimensional random meso-structure model of soil-rock mixture with different stone contents, determining equivalent elastic modulus of a soil-rock mixture with different stone contents and different confining pressures by a corresponding secant elastic modulus when an axial strain is equal to 1%;
based on the equivalent elastic modulus of the soil-rock mixture with different stone contents and different confining pressures, obtaining the macroscopic equivalent elastic modulus of the soil-rock mixture considering stone content and confining pressure by fitting an expression of a binary quadratic polynomial regression model.

Preferably, the construction of the two-dimensional random meso-structure model of the soil-rock mixture comprises the following: based on a grid mapping method, generating the two-dimensional random meso-structure model of the soil-rock mixture with different stone contents according to an original gradation.

Preferably, a calculation formula of the equivalent elastic modulus of the soil-rock mixture is as follows:

$$E = ( {σ}_{1} - {σ}_{3} ) / ε$$

wherein E denotes the macroscopic equivalent elastic modulus of the soil-rock mixture, σ₁-σ₃ denotes deviatoric stress, and ε represents the axial strain.

Preferably, an acquisition of the macroscopic equivalent elastic modulus of the soil-rock mixture considering the stone content and confining pressure comprises the following steps:
based on the equivalent elastic modulus of soil-rock mixture with different stone contents and different confining pressures, obtaining the macroscopic equivalent elastic modulus of soil-rock mixture considering stone content and confining pressure is obtained by fitting the expression of binary quadratic polynomial regression model:

$$E = {E}_{0} + a ζ + b {σ}_{3} + c {ζ}^{2} + d {{σ}_{3}}^{2} + e {ζσ}_{3}$$

where E denotes the macroscopic equivalent elastic modulus of the soil-rock mixture, ζ denotes the stone content, σ₃ denotes a confining pressure, and E₀, a, b, c, d, and e are parameter coefficients of the regression model respectively.

The beneficial effects of the invention are as follows:

According to the screening test, the particle gradation curve of the soil-rock mixture is obtained, and the random meso-structure model of the soil-rock mixture is generated according to the gradation curve, the generated model has geometric similarity with the undisturbed soil-rock mixture, which ensures the credibility of the numerical test results based on this model. This method solves the problem that it is difficult to present effective physical and mechanical parameters in the geological materials of soil-rock mixtures, the randomness of the previous physical and mechanical parameter selection methods is also solved, and the influence of internal structure on the macroscopic mechanical properties of materials is considered and solved.

### BRIEF DESCRIPTION OF THE DRAWINGS

FIG. 1 is a flow chart of the calculation method for the elastic modulus of the soil-rock mixture based on the mesoscopic structure model in the embodiment of the invention;

FIG. 2 is a schematic diagram of the particle gradation curve of the soil-rock mixture of the fault filling in the embodiment of the invention;

FIG. 3 is a two-dimensional random meso-structure model of a fault-filling soil-rock mixture with different stone contents in the embodiment of the invention and;

FIG. 4 is the macroscopic equivalent elastic modulus E of the soil-rock mixture in the embodiment of the invention.

### DETAILED DESCRIPTION OF THE EMBODIMENTS

In order to make the purpose, technical solution, and advantages of the invention more clear, the invention is further described in detail in combination with the attached drawings and an embodiment, it should be understood that the specific embodiment described here is only used to explain the invention and are not used to limit the invention.

### Embodiment 1

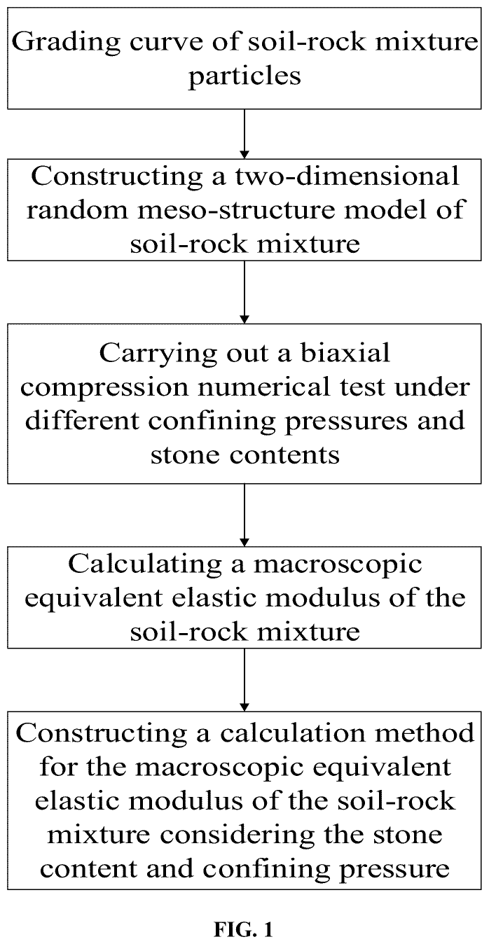

A calculation method for the elastic modulus of the soil-rock mixture based on the mesoscopic structure model is shown in FIG. 1, which comprises the following steps:
S1: The gradation curve of soil-rock mixture particles is obtained by a screening test, and the two-dimensional random meso-structure model of soil-rock mixture with different stone content is constructed according to the gradation curve.

Specifically, the placement area of the soil-rock mixture is subdivided to establish a grid model;
the particle gradation curve of the block stone is obtained, and the number of each particle size block stone in the soil-rock mixture under a certain stone content is calculated by using the particle gradation curve;
according to the number of blocks of each particle size, the simulated block stone particles of multiple gradation segments are generated, and all the simulated block stone particles are combined according to the position to obtain the block stone distribution model;
according to the distance between the centroid point of each grid unit in the grid model and the spherical center point of each simulated block stone particle in the block stone distribution model, each simulated block stone particle is mapped into the grid model to obtain the random meso-structure model of the soil-rock mixture.
S2: The finite element method is used to carry out a biaxial compression numerical test of different confining pressures on the two-dimensional random meso-structure model of soil-rock mixture with different stone contents, and the meso-structure mechanical characteristics and macro-mechanical behavior of soil-rock mixture are obtained.
S3: According to the mechanical characteristics and macroscopic mechanical behavior of the soil-rock mixture, the equivalent elastic modulus of the soil-rock mixture with different stone contents and different confining pressures is determined by the corresponding secant elastic modulus when the axial strain is equal to 1%.
S4: Based on the equivalent elastic modulus of the soil-rock mixture with different stone contents and different confining pressures, the macroscopic equivalent elastic modulus of the soil-rock mixture considering stone content and confining pressure is obtained by fitting the expression of the binary quadratic polynomial regression model.

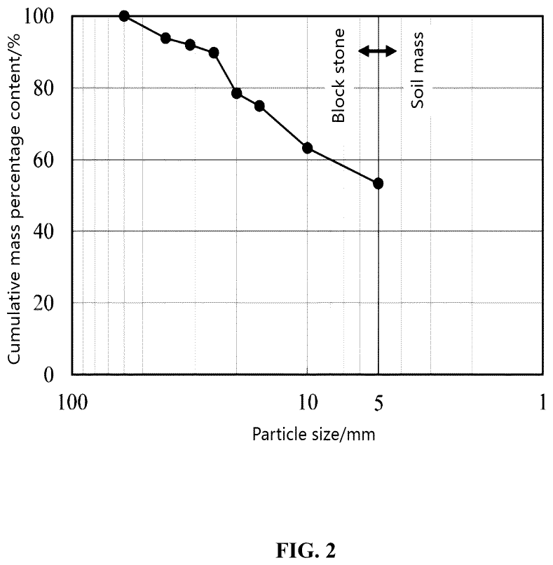

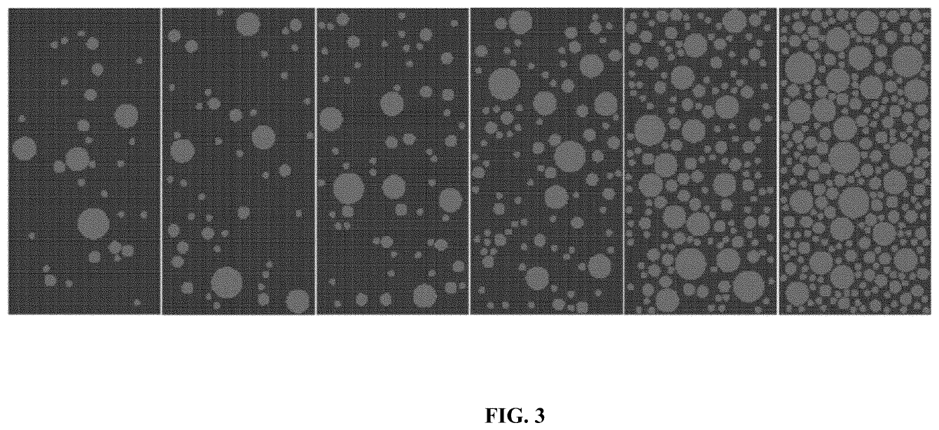

Specifically, FIG. 2 shows the particle gradation curve of the soil-rock mixture obtained by screening test of a fault-filling soil-rock mixture, according to the original gradation, a two-dimensional random meso-structure model of soil-rock mixture with different stone contents is constructed, where the soil-rock mixture sample is set to be a rectangle with a diameter of 200 mm and a height of 400 mm, the grid unit size of the grid model is 2 mm, and the stone contents are 10%, 15%, 20%, 30%, 50%, and 70%, respectively, the two-dimensional random meso-structure model of soil-rock mixture with different stone contents is shown in FIG. 3.

Secondly, the finite element method is used to carry out the biaxial compression numerical tests under the condition of 10%, 15%, 20%, 30%, 50%, and 70% stone contents, and the confining pressures are 200 kPa, 400 kPa, 600 kPa, 800 kPa and 10 MPa respectively.

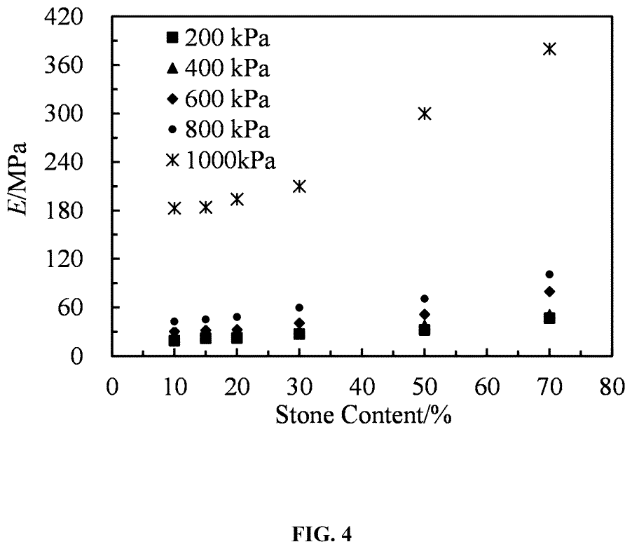

Then, through the corresponding secant elastic modulus when the axial strain is equal to 1%, the macroscopic equivalent elastic modulus E of soil-rock mixture under the conditions of stone content of 10%, 15%, 20%, 30%, 50%, and 70% and confining pressure of 200 kPa, 400 kPa, 600 kPa, 800 kPa, and 10 MPa is determined. the formula is as follows:

$$E = ( {σ}_{1} - {σ}_{3} ) / ε$$

wherein E denotes the macroscopic equivalent elastic modulus of the soil-rock mixture (unit MPa), σ₁-σ₃ denotes the deviatoric stress (unit kPa), and ε represents the axial strain. The calculated macroscopic equivalent elastic modulus E of soil-rock mixture is shown in FIG. 4.

Finally, the binary quadratic polynomial regression model is used to express the relationship between the macroscopic equivalent elastic modulus of the soil-rock mixture and the stone content and confining pressure:

$$E = {E}_{0} + a ζ + b {σ}_{3} + c {ζ}^{2} + d {{σ}_{3}}^{2} + e {ζσ}_{3}$$

where E denotes the macroscopic equivalent elastic modulus of the soil-rock mixture, ζ denotes the stone content (unit %), σ₃ denotes a confining pressure (unit kPa), and E₀, a, b, c, d, and e are parameter coefficients of the regression model respectively. According to the calculated macroscopic equivalent elastic modulus E of the soil-rock mixture, the regression model of macroscopic equivalent elastic modulus E of the soil-rock mixture considering stone content and confining pressure is obtained as follows:

$$E = 10.5724 - 0.4772 ζ + 0.0489 {σ}_{3} + 0.0123 {ζ}^{2} - 3.5656 {e}^{- 3} {σ}_{3}^{2} + 2.9428 {e}^{- 4} {ζσ}_{3}$$

The above content is only the better embodiment of the invention and is not used to limit the invention. Any modification, equivalent replacement, and improvement made within the spirit and principle of the invention should be comprised in the protection scope of the invention.

What is claimed is:

1. A calculation method for an elastic modulus of a soil-rock mixture based on a mesoscopic structure model comprises the following steps: obtaining a grading curve of soil-rock mixture particles by a screening test, and constructing a two-dimensional random meso-structure model of soil-rock mixture with different stone contents according to the grading curve; using a finite element method to carry out a biaxial compression numerical test of different confining pressures on the two-dimensional random meso-structure model of soil-rock mixture with different stone contents, determining equivalent elastic modulus of soil-rock mixture with different stone contents and different confining pressures by a corresponding secant elastic modulus when an axial strain is equal to 1%; based on the equivalent elastic modulus of the soil-rock mixture with different stone contents and different confining pressures, obtaining the macroscopic equivalent elastic modulus of the soil-rock mixture considering stone content and confining pressure is obtained by fitting an expression of a binary quadratic polynomial regression model.

2. The calculation method for the elastic modulus of the soil-rock mixture based on the mesoscopic structure model according to claim 1, wherein the construction of the two-dimensional random meso-structure model of the soil-rock mixture comprises the following: based on a grid mapping method, generating the two-dimensional random meso-structure model of the soil-rock mixture with different stone contents according to an original gradation.

3. The calculation method for the elastic modulus of the soil-rock mixture based on the mesoscopic structure model according to claim 1, wherein a calculation formula of the equivalent elastic modulus of the soil-rock mixture is as follows:
E=(σ₁−σ₃)/ε wherein E denotes the macroscopic equivalent elastic modulus of the soil-rock mixture, σ₁−σ₃ denotes deviatoric stress, and ε represents the axial strain.

4. The calculation method for the elastic modulus of the soil-rock mixture based on the mesoscopic structure model according to claim 3, wherein an acquisition of the macroscopic equivalent elastic modulus of the soil-rock mixture considering the stone content and confining pressure comprises the following steps: based on the equivalent elastic modulus of soil-rock mixture with different stone contents and different confining pressures, obtaining the macroscopic equivalent elastic modulus of soil-rock mixture considering stone content and confining pressure by fitting the expression of binary quadratic polynomial regression model: E=E₀+aζ+bσ₃+cζ²+dσ₃²+eζσ₃ where E denotes the macroscopic equivalent elastic modulus of the soil-rock mixture, ζ denotes the stone content, σ₃ denotes a confining pressure, and E₀, a, b, c, d, and e are parameter coefficients of the regression model respectively.
